(19) United States
(12) Patent Application Publication
(10) Pub. No.: US 2019/0116753 A1
(43) Pub. Date: Apr. 25, 2019

(54) CONTROL OF VARIABLE RATE HEATER IN AN ANIMAL ENCLOSURE

(71) Applicant: The GSI Group LLC, Assumption, IL (US)

(72) Inventors: Martial BERTHOD, St Hubert (CA); Yvon GAUDREAU, St Hubert, QC (CA); Nathan Robert EVERSOLE, Assumption, IL (US); Jonathan BRODEUR, St-Jean sur Richelieu, QC (CA); Benoit R. LABERGE, St Hubert, QC (CA)

(21) Appl. No.: 16/084,824

(22) PCT Filed: Mar. 14, 2017
(86) PCT No.: PCT/US2017/022372

§ 371 Date: Sep. 13, 2018

Related U.S. Application Data
(60) Provisional application No. 62/383,047, filed on Sep. 2, 2016.
(60) Provisional application No. 62/308,033, filed on Mar. 14, 2016.

(51) Int. Cl. A01K 1/00; F24F 11/00

(52) U.S. Cl. CPC A01K 1/0076; F24F 2110/10; A01K 1/0064; F24F 11/0001

(57) ABSTRACT

A method for performing a learning cycle to determine a Start Temperature and a Stop Temperature for a PI loop algorithm is used for operating a climate control system (20) in an animal house (10). The climate control system has at least one climate control input device (21) and at least one heater device (23) and a climate control module (27) that receives input information from the at least one input device and controls the operation of the at least one heater device to regulate the climate in the animal house.

### BACKGROUND OF THE INVENTION

### Field of Invention

This invention relates to climate control systems for buildings used to house animals, and more particularly to a controller and method for operating variable rate heaters.

### Description of Related Art

In buildings that are used to house animals such as poultry, swine or livestock, it is important to maintain a desired building climate. A well-controlled environment involves monitoring and regulating the temperature, relative humidity and air quality in the building. For example, properly controlled temperatures enable animals to use feed for growth rather than for body heat. A properly heated animal house results in lower feed costs and increased animal productivity. Additionally, control over the level of humidity in the building is necessary because excess humidity contributes to animal discomfort and promotes the growth of harmful air born bacteria that can cause respiration diseases. Having an elevated humidity level in the animal house may also lead to more frequent changes of bedding and litter which increases production costs.

To maintain the proper climate in the animal building, various heaters and ventilation fans are used as necessary to maintain the desired temperature and humidity. It is known to use a control unit to automatically control operation of the heaters and ventilation fans located within the building. Sensing devices, such as temperature sensing devices, are used to provide the necessary information to the control unit to enable such automatic control. Improper operation of any of the heaters or ventilation fans can lead to undesirable and even dangerous conditions in the animal building. Air Inlets are used to bring air into the animal house.

### BRIEF SUMMARY OF THE INVENTION

Briefly stated, one aspect of the invention is directed to a method for performing a learning cycle to determine a Start Temperature and a Stop Temperature for a PI loop algorithm used for operating a climate control system in an animal house. The climate control system has at least one climate control input device and at least one heater device and a climate control module that receives input information from the at least one input device and controls the operation of the at least one heater device to regulate the climate in the animal house. The at least one heater device has a valve used to increase heater output. The method includes receiving a heat request signal, starting the at least one heater, increasing the heater output by manipulating the heater valve, receiving an end heat request signal, stopping the heater, recording the temperature as the Stop Temperature, receiving a new heat request, recording the temperature at the new heat request as the Start Temperature, running the PI loop algorithm to cruise on a temperature control point determined using the Start Temperature and the Stop Temperature for a maximum run time, recording a new Stop Temperature as the temperature control point, receiving an end heat request signal and stopping the at least one heater, recording a new Start Temperature as the temperature control point for the PI loop algorithm, and receiving a new heat request signal and starting the at least one heater.

This summary is provided to introduce concepts in simplified form that are further described below in the Description of Preferred Embodiments. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiment.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic drawing of a climate control system of an animal house;

FIG. 2 shows a graphical representation of operation of the climate control system;

FIG. 3 is a flow chart showing operation of the climate control system;

FIG. 4 shows a graphical representation of operation of the climate control system;

FIG. 5 shows a graphical representation of operation of the climate control system;

FIG. 6 is a flow chart showing operation of the climate control system;

FIG. 7 is a perspective view of a heater for the climate control system; and

FIG. 8 is an exploded view of the heater of FIG. 7.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

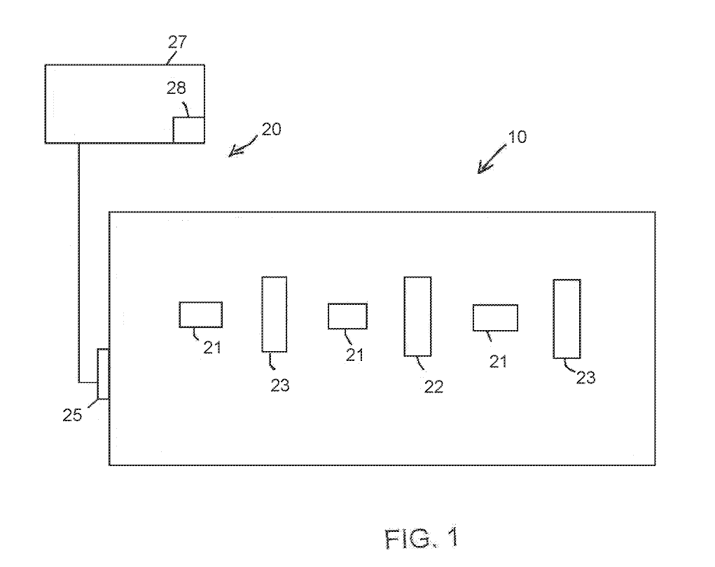

Referring to FIG. 1, a schematic of an animal house 10 having a climate control system 20 is shown. The climate control system 20 has a plurality of climate control input devices, such as temperature or static pressure probes, indicated at 21. The sensing devices 21 may be located in different portions of the animal house 10 so that climate information, such as temperature and static pressure, may be received for the different portions. Although three input devices 21 are shown, it will be understood that this is for purposes of illustrations only, and that additional or fewer input devices may be provided, as required. The climate control system 20 also has a plurality of climate control output devices, such as ventilation fans 22 and/or heaters, indicated at 23 mounted in the building 10. Although three heaters and ventilating fans 22, 23 are shown, it will be understood that this is for purposes of illustrations only, and that additional or fewer heaters and fans may be provided, as required. Various air inlets such as sidewall inlets, ceiling inlets and or tunnel inlets, indicated at 25, are used by the climate control system 20 to control airflow into the animal house 10.

The climate control system 20 has a main control module 27, which incorporates a suitable controller, such as a microprocessor 28, which receives input information from the input devices 21 and regulates the operation of the ventilating fans 22, heaters 23 and the air inlets 25.

During the heating season, use of the heaters 22 is frequently solicited. However, during warmer seasons, heaters 22 are infrequently used in a potentially harsh and humid environment. It is believed that more damage is cause to the heating equipment during times of non-use then during periods of frequent operation. This also may cause problems at restarts when the first cold temperatures come. In one embodiment, the main control module 27 operates in an exercise mode to intermittently force the operation of the heaters 22 during the warmer period to keep the heaters in proper running condition even when heat from the heaters 22 is not needed.

Additionally, the heaters 22 and fans 23 have the capacity of stir the air so as to homogenize the temperature throughout the animal house 10. In one embodiment, when the temperature difference between input devices 21 in different parts of the animal house exceeds a desired threshold, the main control module 27 operates the climate control system 20 in a stir fan mode to force the operation of the fans 23 to properly distribute heat produced by the heaters 22.

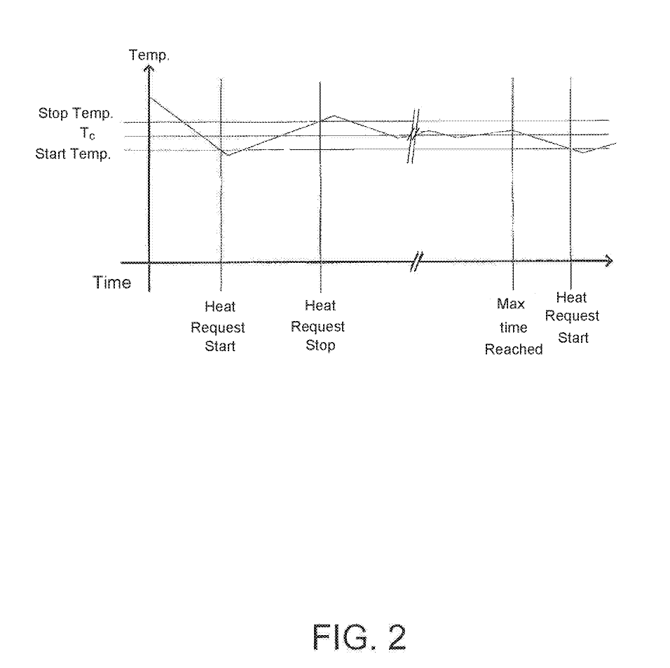

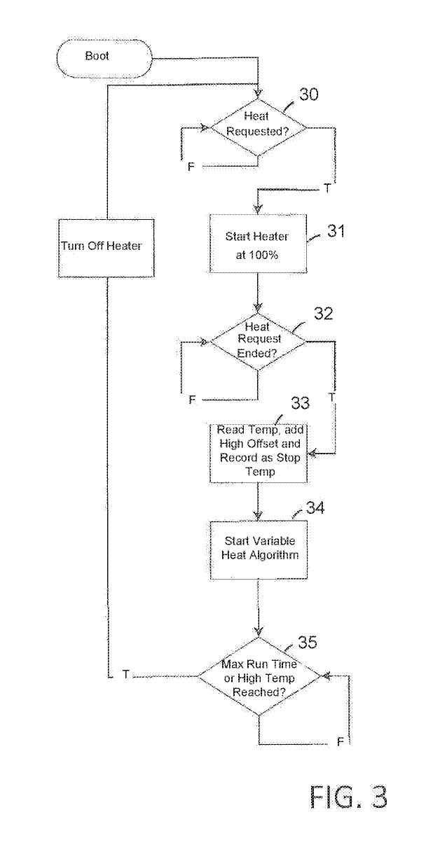

In one embodiment, the main control module 27 may operate in a legacy mode to operate the heaters 22 to solely receive ON and OFF signals from an external thermostat. When operating in the legacy mode, the reception of an OFF signal is interpreted by the heater unit as a temperature setpoint to try and “cruise on” using a PI loop algorithm as shown in FIG. 2. FIG. 3 illustrates a flow chart showing operation of the main control module 27. In this mode, when heat is requested at a Start Temperature at block 30, the main control module 27 starts the heaters 22 at their 100% power level at block 31. The Start Temperature is defined as:

Start Temperature=Stop Temperature−Stop Temperature Offset

In one embodiment, the Stop Temperature Offset is 1 degree Fahrenheit, however, other values for the Stop Temperature Offset may be used. The temperature is monitored by the main control module 27 using the inputs 21 until it is determined that the heat request is to be ended. The Stop Temperature is defined by:

Stop Temperature=temperature at which the heat request turns off+High Offset

The High Offset is a user configured offset. In one example, the High Offset is 0.5 degree Fahrenheit. However, other values for the High Offset may be used. Thus, when the heat request ends at block 32, the main control module 27 reads the temperature and adds The Temperature Offset value and records it as the Stop Temperature at block 33. The Stop temperature is the upper limit of a variable heat algorithm used by the main control module 27 to try to cruise onto a temperature control point Tc. The temperature control point Tc is defined as:

Tc=(Stop Temperature−Start Temp)/2+Start Temp

This mode uses the High Offset parameter to determine the effective stop temperature of the PI loop algorithm and, as a result, derive a setpoint. The temperature at which the OFF signal is received, positively offset by the defined ‘High offset maximum’ parameter determines the ‘stop temperature’. The main control module 27 starts operation of the PI loop algorithm at block 34.

The main control module 27 stops operation of the PI loop algorithm and the heaters 22 are disabled when a ‘Maximum Runtime’ parameter or the Stop Temperature is reached at block 35. The Maximum Runtime is defined as a duration, e.g., in minutes, for which the PI loop algorithm may run continuously without reaching the Stop Temp. If the PI loop algorithm reaches the Maximum Runtime before the Stop Temp, the main control module 27 shuts down regardless of the current temperature.

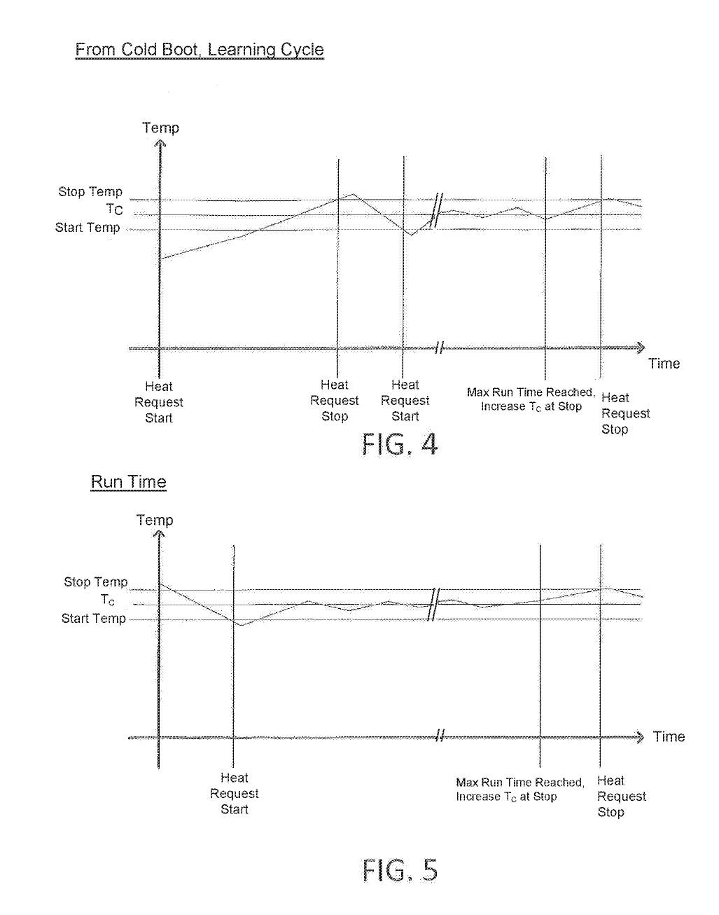

Turning now to FIGS. 4-6, another embodiment of a legacy mode of operation of the climate control system 20 is shown. In this mode, the main control module 27 only receives ON and OFF signals from an external thermostat. Temperature curves are stored on a separate module that decides when to ask for heat and when to stop asking. Based on the reception of those signals, the module 27 operating in an operation mode can learn what the temperature setpoint is and remain on it for a given amount of time. In order to achieve this behavior, the main control module 27 operates in a legacy operation mode that is separated into multiple states as will be described below.

In an idle or default state, operation mode is waiting for an ‘ON’ signal to be triggered while driving the output at 0%. If a ‘Learning’ cycle is unnecessary, the module 27 records the current temperature as the Start temperature and updates its Start Temperature value.

In a learning state, upon reception of an ‘ON’ signal, the module 27 starts a learning cycle to determine start and stop temperatures if they are unknown. The learning cycle may occur for two different reasons. First, the module 27 is starting the Legacy mode for the first time and does not have recorded Start and Stop Temperatures. Second, the module 27 received an ON or OFF signal at a temperature that deviates by more than 5.0 C from the previous temperature. This indicates that the currently stored Start and Stop Temperatures are not properly synchronized with the unit driving the input, they are thus cleared and a new ‘Learning’ cycle is triggered.

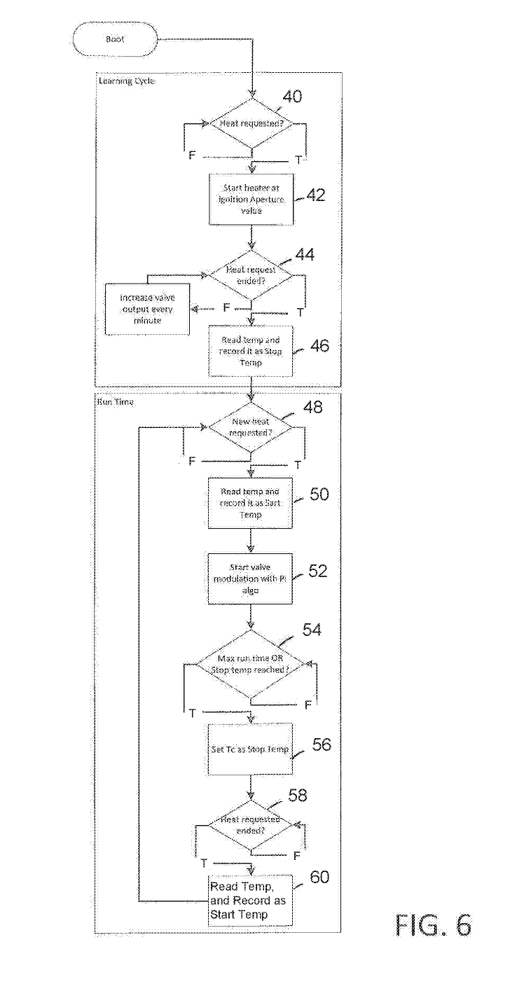

FIG. 6 shows one embodiment of the Learning cycle to be performed at boot time or following some exception. In this embodiment, the heater 22 is started when a contact indicates heat is requested at an ignition aperture valve at block 42. The output percentage is increased until the heat request ends at block 44. When the heat request ends, the heater 22 is stopped. The temperature is recorded as the Stop Temperature at block 46. The system 20 then waits for a new heat request at block 48.

After the new heat request, the temperature is recorded as the Start Temperature at block 50. In the run time portion, the heater 22 is started when a contact indicates heat is requested at an ignition aperture valve. The module 27 determines cruise temperature and runs a PI loop algorithm at block 52. The heat is modulated using the previous Start and Stop Temperatures. The temperature is allowed to cruise for a time specified as the maximum run time at block 54. A new Stop Temperature is recorded as the temperature control point Tc at block 56. When the heat request ends at block 58, the heater 22 is stopped. A new Start Temperature is recorded as the temperature control point for the PI loop algorithm at block 60. A new heat request signal is received and the at least one heater is started.

In one embodiment, the system 20 discards Start Temperature if there is a difference between current and previous start temperatures of more than 5 degrees C. Desirably, the data does not persist through power cycles. A learning cycle is performed if the Start Temperature changes by more than a preselected temperature difference, such as for example 5 degrees C. Also, a learning cycle is performed if the Stop Temperature changes by more than a preselected temperature difference, such as for example 5 degrees C.

In a modulating state, upon reception of an ‘ON’ signal, the module 27 modulates between the Start Temperature and Stop Temperature if they are known. In a similar fashion to the standalone operation mode, the module 27 will run a variable heat algorithm to modulate the heat output and attempt to cruise around the control temperature (defined as the midway point between the ‘Start Temperature’ and ‘Stop Temperature’ by adjusting a heater valve.

Once the exit criteria of modulation is reached (e.g., reception of an OFF signal, max runtime reached, stop temperature reached), the module 27 starts seeking an ‘OFF’ signal. A seeking the off signal state is similar to the ‘Learning’ state. The temperature is increased at a constant rate until the reception of an OFF signal. Once an OFF signal is received, the temperature is recorded as the new ‘Stop Temperature’. If however, an OFF signal is never received and the temperature reaches more than a preselected temperature difference, such as for example 5.0 C above the currently recorded ‘Stop Temperature’, the control temperatures are cleared and a new ‘Learning’ cycle is triggered.

In a failsafe mode, the temperature is continuously monitored such that if the temperature drops below a ‘Failsafe Temperature Setpoint’ parameter (defined by the last temperature at which the input was enabled minus the ‘Failsafe Offset’ defined in the UI of the top module), the module 27 assumes that the thermostat driving the input is malfunctioning and automatically falls back in an autonomous Failsafe mode.

If the heater start temperature on the ventilation controller falls below the failsafe start parameter on the main control module 27, or when a clean mode is selected, the system 20 desirably performs a power cycle for the climate control system 20 to take the new value into account. After the power is cycled, the start and failsafe temperatures are re-established. In one embodiment, the start temperature is set to 45 degrees Fahrenheit by default.

To help the climate control system 20 follow a temperature curve from a ventilation controller, an additional parameter can be set. The “Failsafe Curve Adjustment” parameter is used to automatically decrease the last recorded Start and Stop Temperature by the same amount every week. This feature only activates when the climate control system 20 has not turned on for more than one week. With this feature active and correctly adjusted, the failsafe temperature will never be reached during normal operation. Failsafe mode will continue to function when required if there is a loss of control signal. Once the start temperature reaches a preselected temperature, such as 45 degrees Fahrenheit, the “Decrease Per Week” will deactivate. If it is desired to deactivate the “Decrease Per Week” feature permanently, the value may be adjusted to zero.

The climate control system 20 has a failsafe mode of operation. Desirably, the failsafe mode cannot be manually selected. Instead, it is automatically entered when the temperature drops below a specific temperature setpoint. Desirably, this can only happen when the inputs of the climate control system 20 are driven by another entity. Desirably, the Standalone mode which functions autonomously cannot enter in the Failsafe mode.

In one embodiment, logic is added to the main control module 27 to allow the failsafe mode to follow a curve dropping the values to follow the controller set point in conjunction with seeing the heater not start for a period of time.

In this mode, the climate control system 20 controller will operate in an attempt to keep a relatively constant temperature while whatever equipment that was driving the previous state the module was is being repaired. Variable Input (0-10V), Variable Input (4-20 mA) and Legacy operation modes may fall into Failsafe mode at any time if the temperature read from the attached probe falls at or below the Failsafe Temperature Setpoint. This value can be derived from the temperature at which the previous mode's input was enabled minus the Failsafe Offset (defined in the climate control system 20). The control will use the temperature read when the attached input was last enabled (also equals to ‘Failsafe Temperature Setpoint’+‘Failsafe Offset’) as a setpoint and parameters ‘Start temperature offset’ and Stop temperature offset defined in the user interface settings to drive the controller. The notion of Maximum run time is foregone in this mode.

In one embodiment, there are three ways to exit the failsafe mode. First, the system 20 is powered off. Once rebooted, the module 27 will continue operating with the previously configured operation mode. Should the operation mode's inputs still be inoperative, the module 27 will fall back into failsafe. Second, an operator can intentionally exit Failsafe mode from a user interface (by selecting a new operation mode). Should the new operation mode's inputs be inoperative, the module 27 returns into Failsafe mode. Additionally, the Failsafe mode is can be exited when a failsafe timer (for example, a duration of 4 hours) has elapsed. At this point, the module 27 will fall back to the previous operation mode. Should the operation mode's inputs still be inoperative, the module returns to Failsafe mode after a 5 minutes delay.

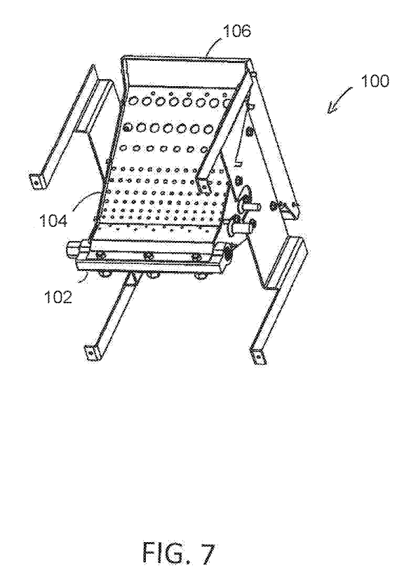

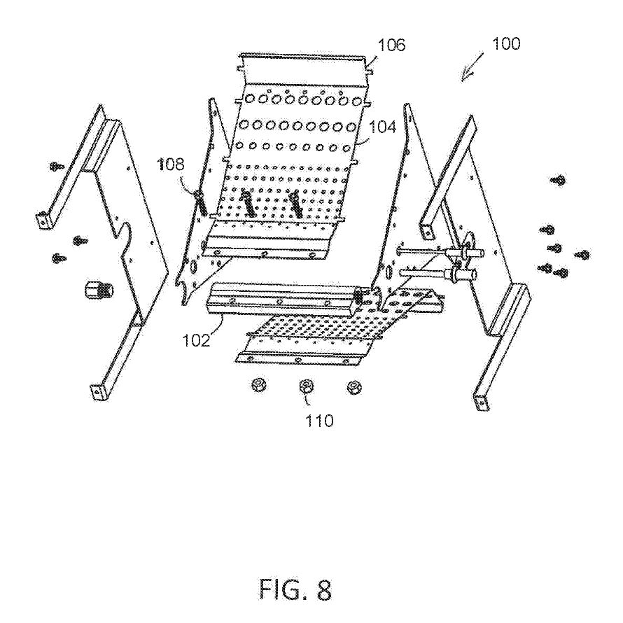

FIGS. 7 and 8 illustrate one embodiment of a burner 100 used by the heater 22 of the climate control system 20. In the illustrated embodiment, the burner 100 includes a fuel manifold 102, perforated air-mixing plates 104 coupled to the fuel manifold 102 to define a fuel-air mixing region there between above the fuel manifold, and unperforated air-deflector wings 106. Each unperforated air-deflector wing 106 is coupled to one of the perforated air-mixing plates 104 such that each unperforated air-deflector wing extends upwardly from and at an angle to the perforated air-mixing plate to which it is coupled. In one embodiment, suitable bolts 108 and nuts 110 are used to attach the air-mixing plates 104 to the fuel manifold 102. A heater valve 110 is used to adjust fuel flow rate used by the heater 22 to adjust heat output.

The design of the heater 22 desirably uses a single profile casting for the manifold 102 that allows the casting to be slid into position after the sheet metal parts are assembled. The shape of the manifold 102 as a single profile desirably allows for cheaper casting with less machined surfaces. Desirably, instead of using bolted flanges, the ends are desirably threaded, allowing a standard pipe nipple to be threaded in.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A method for performing a learning cycle to determine a Start Temperature and a Stop Temperature for a PI loop algorithm used for operating a climate control system in an animal house, the climate control system having at least one climate control input device and at least one heater device and a climate control module that receives input information from the at least one input device and controls the operation of the at least one heater device to regulate the climate in the animal house, wherein the at least one heater device has a valve used to increase heater output, the method comprising:
receiving a heat request signal;
starting the at least one heater;
increasing the heater output by manipulating the heater valve;
receiving an end heat request signal;
stopping the heater;
recording the temperature as the Stop Temperature;
receiving a new heat request;
recording the temperature at the new heat request as the Start Temperature;
running the PI loop algorithm to cruise on a temperature control point determined using the Start Temperature and the Stop Temperature for a maximum run time;
recording a new Stop Temperature as the temperature control point;
receiving an end heat request signal and stopping the at least one heater;
recording a new Start Temperature as the temperature control point for the PI loop algorithm; and
receiving a new heat request signal and starting the at least one heater.

2. The method of claim 1 wherein the learning cycle is performed when the module is starting for the first time and does not have recorded Start and Stop Temperatures.

3. The method of claim 1 wherein the learning cycle is performed when the control module receives a signal to start the at least one heater at a temperature that deviates by more than a preselected amount from the recorded start temperature.

4. The method of claim 1 wherein the learning cycle is performed when the control module receives a signal to turn off the at least one heater at a temperature that deviates by more than a preselected amount from the recorded stop temperature.
